(19) United States
(12) Patent Application Publication
(10) Pub. No.: US 2015/0259008 A1
(43) Pub. Date: Sep. 17, 2015

(54) VEHICULAR CONTROL APPARATUS

(71) Applicant: Hiroaki Seguchi, Toyota-shi (JP)

(72) Inventor: Hiroaki Seguchi, Toyota-shi (JP)

(73) Assignee: TOYOTA JIDOSHA KABUSHIKI KAISHA, Toyota-shi (JP)

(21) Appl. No.: 14/431,597

(22) PCT Filed: Dec. 28, 2012
(86) PCT No.: PCT/JP2012/008439

§ 371 Date: Mar. 26, 2015

(51) Int. Cl. B62D 15/02

(52) U.S. Cl. CPC B62D 15/0255

(57) ABSTRACT

A control apparatus for a vehicle including a lane keeping assist control mechanism configured to execute lane keeping assist control for preventing the vehicle from deviating from a running lane by the power steering mechanism; and an automatic stop control mechanism configured to stop the engine upon fulfillment of predetermined automatic stop conditions during running of the vehicle, the automatic stop conditions include a condition that the lane keeping assist control not be executed.

### TECHNICAL FIELD

The invention relates to a vehicular control apparatus, and more particularly, to a vehicular control apparatus that automatically stops an engine upon fulfillment of a predetermined automatic stop condition during running with a view to reducing fuel consumption.

### BACKGROUND ART

In a vehicular control apparatus for an automobile or the like, idling stop control for reducing fuel consumption by automatically stopping an engine in an automatically restartable manner upon fulfillment of a predetermined automatic stop condition has been prevailing in a full-fledged manner, and a higher degree of reduction in fuel consumption has been demanded. As a vehicular control apparatus that executes such control, there is known, for example, a control apparatus that enables a vehicle to coast by stopping an engine since during deceleration at the time of full closure of an accelerator or prior to the stop of running even in the process of running (e.g., see Patent Document 1).

On the other hand, with a view to enhancing the safety of a vehicle and alleviating the driving load, lane keeping assist control for outputting a warning or providing assistance in steering for driving support when it is determined that the vehicle may deviate from a lane, namely, lane keeping control has also been prevailing. As a vehicular control apparatus that executes such control, there is known, for example, a control apparatus that prevents a vehicle from deviating from a lane by automatically controlling an electric power steering device (e.g., see Patent Document 2).

### RELATED ART DOCUMENTS

### Patent Documents

Patent Document 1: Japanese Patent Application Publication No. 2002-227885 (JP-2002-227885 A)

Patent Document 2: Japanese Patent Application Publication No. 2000-142441 (JP-2000-142441 A)

### SUMMARY OF THE INVENTION

### Problem to be Solved by the Invention

However, with the conventional vehicular control apparatuses as described above, the engine is automatically stopped upon fulfillment of the automatic stop condition even during the running of the vehicle. Therefore, while the effect of reducing fuel consumption can be enhanced, the generation of electric power by an alternator that is driven by the motive power from the engine is also stopped since during the running of the vehicle, so the following problems are caused.

That is, if control in which the consumption of electric power by an electric actuator for electric power steering continues, such as lane keeping assist control, is executed in the case where the engine is automatically stopped during the running of the vehicle, the electric power supplied to the electric actuator may become insufficient, or the discharge amount of a battery may increase, so the deterioration in the battery may become likely to progress.

Besides, when the engine is stopped during the running of the vehicle, a change occurs in the engine braking effect or the like. Therefore, there is an apprehension that adverse effects such as a change in the effect of lane keeping assist control from its normal effect and an incongruous steering feeling imparted to a driver may be caused.

It is thus an object of the invention to provide a vehicular control apparatus that makes it unlikely to adversely affect other types of control or incur a shortage of the electric power supplied to an electric actuator or a deterioration in a battery even in the case where an attempt is made to reduce fuel consumption by automatically stopping an engine during the running of a vehicle.

### Means for Solving the Problem

In order to achieve the aforementioned object, a vehicular control apparatus according to the invention is mounted on a vehicle that is equipped with an engine that generates a motive power, a transmission that transmits the motive power of the engine, a generator that is driven by the engine, and a power steering mechanism that provides assistance in operating a steering wheel through the use of an electric power generated by the generator. The vehicular control apparatus is configured to include a lane keeping assist control mechanism that executes lane keeping assist control for preventing the vehicle from deviating from a running lane with the aid of the power steering mechanism, and an automatic stop control mechanism that automatically stops the engine upon fulfillment of predetermined automatic stop conditions during the running of the vehicle. The vehicular control apparatus is characterized in that the automatic stop conditions include a condition that the lane keeping assist control not be executed.

Owing to this configuration, according to the invention, when the automatic stop conditions are fulfilled during the running of the vehicle, the automatic stop control mechanism operates in accordance with the driving state of the vehicle, and the engine is automatically stopped during the running of the vehicle. However, the automatic stop conditions mentioned herein include the condition that lane keeping assist control not be executed. Accordingly, the engine is not automatically stopped when electric power continues to be consumed in the power steering mechanism that executes lane keeping assist control. As a result, it is unlikely to adversely affect other types of control or incur a shortage of the electric power supplied to the power steering mechanism or a deterioration in the battery.

In the vehicular control apparatus according to the invention, the lane keeping assist control mechanism may be controllable to be changed over to a standby mode in which the lane keeping assist control is permitted to be executed and a non-standby mode in which the lane keeping assist control is restrained from being executed, and the automatic stop conditions may include a condition that the lane keeping assist control mechanism be changed over to the non-standby mode.

Owing to this configuration, when the lane keeping assist control mechanism is under the standby mode in which assist steering for lane keeping is carried out immediately after the possibility of the vehicle deviating from a lane arises, the automatic stop control mechanism does not automatically stop the engine. Accordingly, under a situation where assistance in steering can be provided by the power steering mechanism for lane keeping at a deceleration stage or the like prior to coasting or stoppage of the vehicle, the automatic stop control mechanism does not automatically stop the engine. As a result, the driveability or the kinetic performance of the vehicle is not degraded.

In the vehicular control apparatus according to the invention, the lane keeping assist control mechanism may have a mode changeover operation portion that enables the control of a changeover between the standby mode and the non-standby mode through a manual operation input.

Owing to this configuration, the processing load of the control unit under the non-standby mode can be alleviated.

In the vehicular control apparatus according to the invention, the vehicle may be provided with a disconnection mechanism that can disconnect a motive power transmission path from the engine to the transmission, and the automatic stop control mechanism may cause the vehicle to coast by autonomously operating the engine while disconnecting the motive power transmission path from the engine to the transmission with the aid of the disconnection mechanism when all the automatic stop conditions other than a condition that the lane keeping assist control mechanism be changed over to the standby mode are fulfilled among the automatic stop conditions.

In this case, fuel consumption can be reduced by autonomously operating the engine. That is, the engine and the transmission are decoupled from each other by the disconnection mechanism while maintaining the electric power of the power steering mechanism, so the friction of the engine is not transmitted to wheel sides, so the engine braking force decreases. This results in an increase in the coasting distance and an improvement in fuel economy. Incidentally, the disconnection mechanism can decouple the engine from the wheels. A clutch between the engine and the transmission is preferably employed as the disconnection mechanism.

In the vehicular control apparatus according to the invention, the disconnection mechanism may be configured to include a clutch that can disconnect and connect the motive power transmission path from the engine to the running drive mechanism.

Owing to this configuration, the motive power transmission path from the engine to the running drive mechanism can be smoothly disconnected and connected. The state of disconnection can be smoothly cancelled when the motive power transmission path is connected etc. after the braking state or the like prior to coasting or stoppage of the vehicle is cancelled for one reason or another.

In the vehicular control apparatus according to the invention, the power steering mechanism may have an electric actuator that operates based on a steering input signal corresponding to a steering input to a steering input member, and may generate a steering assist force with the aid of the electric actuator, and the lane keeping assist control mechanism may generate a steering input signal for assist steering for preventing the vehicle from deviating from a running lane, and may cause the power steering mechanism to carry out lane keeping assist steering corresponding to the steering input signal for assist steering.

Owing to this configuration, the control executed by the lane keeping assist control mechanism and the automatic stop control mechanism can be more accurately and safely controlled.

### Effect of the Invention

According to the invention, the automatic stop conditions for automatically stopping the engine during the running of the vehicle include the condition that lane keeping assist control not be executed. Therefore, it is possible to provide a vehicular control apparatus that makes it unlikely to adversely affect other types of control or deteriorate a battery even in the case where an attempt is made to reduce fuel consumption by automatically stopping an engine during the running of a vehicle.

### BRIEF DESCRIPTION OF THE DRAWINGS

FIG. 1 is a schematic block diagram of a vehicular control apparatus according to one embodiment of the invention.

FIG. 2(a) is an illustrative view of the priorities and start timings of lane keeping assist steering control and deceleration engine automatic stop control in the vehicular control apparatus according to the embodiment of the invention, and FIG. 2(b) is an illustrative view of the priorities and start timings of electric power steering control at or above a certain output and deceleration engine automatic stop control in the vehicular control apparatus according to the embodiment of the invention.

FIG. 3 is an illustrative view of changes in a vehicle state at the time of pseudo-deceleration S&S in an LK control standby state in the vehicular control apparatus according to the embodiment of the invention.

FIG. 4 is a flowchart of a first priority setting process for setting priorities of LK control and deceleration S&S depending on occasions in the vehicular control apparatus according to the embodiment of the invention.

FIG. 5 is a flowchart of a second priority setting process for setting priorities of EPS control at or above a certain output and deceleration S&S depending on occasions in the vehicular control apparatus according to the embodiment of the invention.

### MODE FOR CARRYING OUT THE INVENTION

A preferred embodiment of the invention will be described hereinafter with reference to the drawings.

### Embodiment

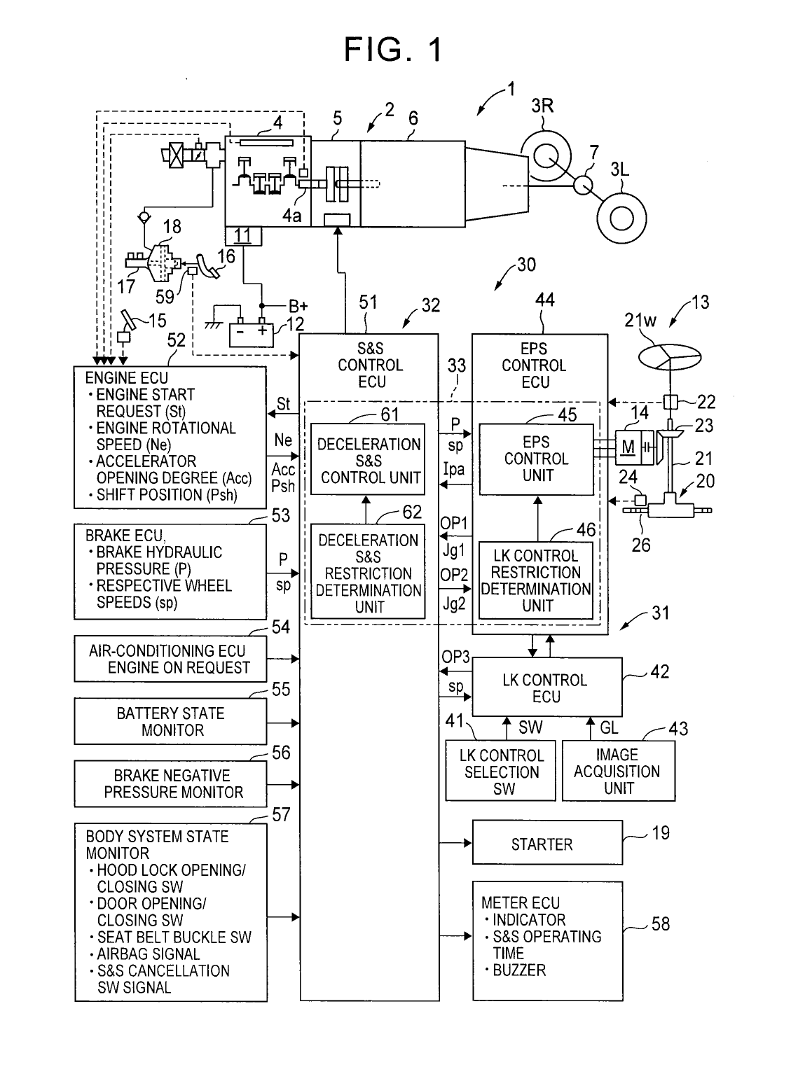

FIGS. 1 to 3 show a schematic configuration of a vehicular control apparatus according to the embodiment of the invention.

First of all, the configuration will be described.

As shown in FIG. 1, a vehicle 1 according to the present embodiment of the invention has right and left driving wheels, for example, rear wheels 3R and 3L and driven wheels (not shown), for example, front-right and front-left wheels, and can run when the rear wheels 3R and 3L are rotationally driven by a running drive mechanism 2.

The running drive mechanism 2 is constituted of an engine 4 as a running drive source, and a shift mechanism 6 that inputs a rotational motive power output from the engine 4 via a clutch mechanism 5.

The engine 4 is a multi-cylinder four-cycle internal combustion engine, for example, a gasoline engine, and can output a rotational motive power from a crankshaft 4a as an output shaft.

The clutch mechanism 5 can disconnect and connect the motive power transmission path from the engine 4 to the rear wheels 3R and 3L, for example, the motive power transmission path from the engine 1 to the shift mechanism 6. This clutch mechanism 5 is constituted by, for example, an electromagnetic clutch-equipped dry friction clutch that can be electromagnetically controlled to be changed over to be turned ON/OFF. It should be noted, however, that the clutch mechanism 5 may be a wet clutch, or may be constituted by a fluid coupling or a torque convert that can be electromagnetically locked up or stopped from being locked up.

When a rotational motive power from the engine 4 is transmitted to the shift mechanism 6 (the transmission) via the clutch mechanism 5, the shift mechanism 6 (the transmission) changes the speed of the rotational motive power with the aid of a known multi-stage shift mechanism, outputs the rotational motive power to a differential device 7, and generates a vehicle running driving force of the vehicle 1 by the rear wheels 3R and 3L that are drivingly coupled to the differential device 7 in a differentiable manner.

Besides, the vehicle 1 is mounted with an alternator 11 as a generator that is driven by a rotational motive power from the crankshaft 4a of the engine 4, a battery 12 that is charged by the alternator 11, and an electric power steering mechanism 13 that provides assistance in operating a steering wheel by operating an electric actuator 14 based on an electric power of this battery 12.

Furthermore, the vehicle 1 is mounted with an accelerator pedal 15 that is operated through depression to request an increase in the output of the engine 4, a brake pedal 16 that is operated through depression to request the braking of the vehicle 1, a master cylinder 17 that generates a brake hydraulic pressure corresponding to a depression operational force applied to the brake pedal 16, a negative pressure booster 18 that boosts an operational force applied to the master cylinder 17 from the brake pedal 16, and a starter motor 19 that starts the engine 4.

Although not shown in detail, the alternator 11 is configured to include an AC generator that generates an electric power in accordance with a rotational motive power from the engine 4, a regulator that regulates a voltage of the generated electric power, a rectifier that converts the AC generated electric power into a DC electric power, and the like.

The battery 12 is constituted by a known lead storage battery, supplies an electric power to various auxiliaries such as the starter motor 19 and the like, various electric actuators such as the electric actuator 14 and the like, and other electric components, and functions also as an electric power supply of a control system that will be described later.

The electric power steering mechanism 13 inputs a steering assist torque from the electric actuator 14 to a steering shaft 21 of a steering mechanism 20 of, for example, rack-and-pinion type, and can change the orientation of the front wheels as steered wheels in a vehicle lateral direction in accordance with a steering input that is input from a wheel, for example, a steering wheel 21w (a steering input member) that is fitted to the steering shaft 21. Incidentally, in FIG. 1, the electric actuator 14 is a three-phase motor, for example, a steering assist motor that is equipped with an electromagnetic clutch. Then, a rotational motive power from this electric actuator 14 is changed in direction by a bevel gear 23, and is applied as a supplementary operational force in the rotational direction of the steering shaft 21. It should be noted, however, that the electric power steering mechanism 13 may apply an assist steering force in the axial direction of a rack of a front-wheel steering mechanism.

The electric power steering mechanism 13 is fitted with a steering input sensor 22 that detects a steering torque, a steering angle, a steering angular velocity or the like as a steering input to the steering wheel 21w, and a turning angle sensor 24 that detects an operational position of a rack 26 of the steering mechanism 20 corresponding to the steering input to the steering wheel 21w, namely, a turning angle of the front wheels as steered wheels from a reference direction during the straight-running of the vehicle.

The master cylinder 17 pressurizes a hydraulic oil therein in accordance with an input from the brake pedal 16 side with the aid of a piston, and can supply a brake hydraulic pressure to a hydraulic brake system (not shown) that brakes the rear wheels 3R and 3L and the front wheels of the vehicle 1.

Although not shown in detail, the negative pressure booster 18 partitions the interior of a power cylinder into a negative pressure introduction chamber and an atmosphere introduction chamber with the aid of a power piston that is equipped with a diaphragm, and increases a differential pressure between a negative pressure chamber and an atmospheric pressure chamber upon a request for braking by a valve that responds to a depression operational force of the brake pedal 16, for example, an atmosphere introduction valve. Thus, the negative pressure booster 18 boosts the depression operational force applied to the brake pedal 16, and inputs the boosted depression operational force to the master cylinder 17 from the power piston. Incidentally, a negative pressure is accumulated in the negative pressure introduction chamber of the negative pressure booster 18, through the use of a negative pressure in an intake pipe of the engine 4. Besides, a return spring (not shown) is interposed between the power cylinder and the power piston.

The starter motor 19 is constituted by, for example, a DC motor, and outputs a rotational motive power for cranking the engine 4 when a starting current is supplied thereto.

This starter motor 19 is activated when a starter switch (not shown) that issues a command to start the engine 4 is operated through depression, or when an automatic restart command is issued from an S&S control ECU 51 that will be described later. Besides, the starter motor 19 is stopped when the starter switch is operated through depression during operation of the engine 4, or when the engine 4 has reached a predetermined start completion rotational speed (rpm) or a predetermined start permission period has elapsed.

Besides, the vehicle 1 is mounted with a control apparatus 30 (a vehicular control apparatus) that executes fuel consumption reduction control and driving support control.

This control apparatus 30 is configured to include an LK control mechanism 31 that executes lane keeping assist control (hereinafter referred to as LK control), an idling stop control mechanism 32 that executes so-called deceleration idling stop-and-start control (hereinafter referred to as deceleration S&S control) to execute idling stop control from a deceleration running stage of the vehicle 1, and a control unit 33 that controls the operations of the LK control mechanism 31 and the idling stop control mechanism 32.

The LK control mechanism 31 has a lane deviation warning function for outputting a warning with the aid of a buzzer or the like in the case where the vehicle 1 may deviate from a running lane when the current driving operation by a driver lasts, and a lane keeping assist function for applying an assist steering force for lane keeping through the use of the electric power steering mechanism 13 such that the vehicle 1 runs in the vicinity of a center of a running lane.

This LK control mechanism 31 is configured to include an LK control selection switch 41, an LK control ECU 42, an image acquisition unit 43, and an EPS control ECU 44.

The LK control selection switch 41 is a switch as a mode changeover operation portion that can selectively set either one of a standby mode in which LK control is requested and a non-standby mode in which LK control is not requested, and is installed in a vehicle interior of the vehicle 1.

The LK control ECU 42 can swiftly and accurately apply an assist steering force for lane keeping to the steering shaft 21 in case of necessity by selectively operating the electric actuator 14 of the electric power steering mechanism 13 in accordance with a running state of the vehicle 1, for example, a vehicle speed sp, a possibility of deviation from a lane, or the like, when the standby mode is selectively set by the LK control selection switch 41.

The image acquisition unit 43 can acquire a road surface image in front of the vehicle with the aid of, for example, an onboard camera, and can acquire image information corresponding to a lane by executing a feature extraction process for recognizing a linear element along a running lane, for example, a white line painted on a road surface or the like.

Besides, the LK control ECU 42 refers to information acquired by the image acquisition unit 43 and vehicle speed information from the idling stop control mechanism 32 side on a predetermined cycle when the standby mode is selectively set by the LK control selection switch 41. When the current running state of the vehicle 1 is continued for a predetermined time or more, the LK control ECU 42 determines whether or not the vehicle 1 may deviate from a running lane. Then, when it is determined that the vehicle 1 may deviate from the lane, the LK control ECU 42 generates a steering input signal for lane keeping assist steering to prevent the vehicle 1 from deviating from the lane, and outputs the generated steering input signal to the EPS control ECU 44.

In order to function as the EPS control unit 45 and the LK control restriction determination unit 46, the EPS control ECU 44 has a program, a memory area and the like for exerting those functions.

The EPS control unit 45 variably controls a supplementary steering force applied to the steering shaft 21 from the electric actuator 14, in accordance with a steering input to the steering wheel 21w as obtained from the steering input sensor 22 and a front-wheel turning angle corresponding to an operational position of the rack 26 as obtained from the turning angle sensor 24.

When the steering input signal for lane keeping assist steering is input to the LK control restriction determination unit 46 from the LK control ECU 42, the LK control restriction determination unit 46 determines whether or not lane keeping assist steering should be restricted. Only when lane keeping assist steering is permitted, the LK control restriction determination unit 46 operates the EPS control unit 45 based on the steering input signal from the LK control ECU 42, and causes the electric power steering mechanism 13 to carry out lane keeping assist steering.

Besides, the LK control restriction determination unit 46 outputs a determination result Jg1 as to whether or not lane keeping assist steering should be restricted, and an LK control request state signal OP1 indicating whether or not the steering input signal for lane keeping assist steering from the LK control ECU 42 has been output, to the idling stop control mechanism 32 side. Incidentally, a case where the LK control restriction determination unit 46 does not permit lane keeping assist steering will be described later. Besides, a state signal OP1 indicating whether or not the steering input signal for lane keeping assist steering from the LK control ECU 42 has been output may be output to the idling stop control mechanism 32 side from the LK control ECU 42.

The idling stop control mechanism 32 is an automatic stop control mechanism that is configured to include an idling stop-and-start control ECU (hereinafter referred to as an S&S control ECU) 51, an engine ECU 52, a brake ECU 53, an air-conditioning ECU 54, a battery state monitor 55, a brake negative pressure monitor 56, and a body system state monitor 57.

It should be noted herein that a current signal Ipa of the electric actuator 14 indicating an operation state of the electric power steering mechanism 13 is input to the S&S control ECU 51 from the EPS control ECU 44, and that the determination result Jg1 from the LK control restriction determination unit 46 and the state signal OP1 are input to the S&S control ECU 51. Besides, while driving state signals such as an engine rotational speed Ne, an accelerator opening degree Acc, a shift position Psh and the like are fetched into the S&S control ECU 51 from the engine ECU 52, an engine start request signal St is output to the engine ECU 52 from the S&S control ECU 51 when automatic restart of the engine 4 is requested.

Besides, a brake hydraulic pressure signal from the brake ECU 53 and wheel speed signals of the respective wheels such as the rear wheels 3R and 3L and the like are fetched into the S&S control ECU 51. Also, an engine ON request signal that is output from the air-conditioning ECU 54 when a large load is applied to an air-conditioner is fetched into the S&S control ECU 51. Furthermore, detection information on a battery remaining capacity, for example, a battery voltage or a battery current from the battery state monitor 55, negative pressure information from the brake negative pressure monitor 56 that monitors a negative pressure level in the negative pressure chamber of the negative pressure booster 18, and a detection signal of a brake switch 59 that detects the presence/absence of the operation of the brake pedal 16 through depression are fetched into this S&S control ECU 51.

On the other hand, the S&S control ECU 51 outputs an automatic stop request signal for automatically stopping the engine 4 to the engine ECU 52 upon fulfillment of a predetermined automatic stop condition, and outputs an automatic restart request signal for automatically restarting the engine 4 to the engine ECU 52 upon fulfillment of a predetermined automatic restart condition (referred to also as a return condition).

The predetermined automatic stop condition mentioned herein is a first automatic stop condition that requests fulfilment of three condition, for example, a condition (a1) that the vehicle speed be equal to or lower than a set vehicle speed, a condition (b1) that the accelerator pedal 15 be returned to a return position to assume an accelerator fully-closed state, and a condition (c1) that a depression force as a braking request operational force be applied to the brake pedal 16.

Alternatively, the predetermined automatic stop condition is a second automatic stop condition that requests fulfillment of two conditions, namely, a condition (a2) that the vehicle speed be higher than the set vehicle speed and a condition (b2) that the accelerator pedal 15 be returned to the return position to assume the accelerator fully-closed state.

That is, the S&S control ECU 51 can automatically stop the engine 4 by outputting an automatic stop request signal to the engine ECU 52 upon fulfillment of one of the first automatic stop condition and the second automatic stop condition.

The predetermined automatic restart condition is, for example, a condition (d) that the driver have removed his/her foot from the brake pedal.

Upon fulfillment of this automatic restart condition under a state where the engine 4 is automatically stopped, the S&S control ECU 51 supplies an electric power to the starter motor 19 to crank the engine 4, and outputs an automatic restart request signal to the engine ECU 52 to cause the engine ECU 52 to execute fuel injection of the engine 4 or the like, thus restarting the engine 4.

In addition, the S&S control ECU 51 fetches the presence of a standby state that enables the start of operation of lane keeping assist steering from the LK control ECU 42, fetches an LK control state signal OP3 including an output situation of a lane deviation warning and the like from the LK control ECU 42, and causes the meter ECU 58 to execute the displaying of an indicator of the lane deviation warning, the outputting of a warning buzzer, and the displaying and outputting of the execution time, ratio and the like of S&S control that is currently being executed.

More specifically, in addition to the function of a deceleration S&S control unit 61 that executes deceleration S&S control as described above, the S&S control ECU 51 has the function of a deceleration S&S restriction determination unit 62 that determines whether or not a predetermined restrictive condition for restricting the execution of deceleration S&S control by this deceleration S&S control unit 61 is fulfilled. That is, the S&S control ECU 51 has a program, a memory area and the like for exerting the functions of the deceleration S&S control unit 61 and the deceleration S&S restriction determination unit 62.

The deceleration S&S restriction determination unit 62 determines whether or not the vehicle assumes a vehicle state where the execution of S&S control should be restricted, by determining whether or not the vehicle state corresponds to a predetermined restrictive condition. When the predetermined restrictive condition is fulfilled, the deceleration S&S restriction determination unit 62 stops outputting an automatic stop request signal to the engine ECU 52 even in the case where the predetermined automatic stop condition is fulfilled. Besides, the deceleration S&S restriction determination unit 62 outputs a determination result Jg2 as to whether or not deceleration S&S control should be restricted, and a deceleration S&S control state signal OP2 indicating whether or not deceleration S&S control is executed in the idling stop control mechanism 32, to the EPS control ECU 44 side of the LK control mechanism 31.

The predetermined restrictive condition mentioned herein is fulfilled in response to the fulfillment of one of restrictions, for example, (e) that the steering wheel 21w is in the process of being operated with a steering input equal to or larger than a predetermined value, (f) that the load of the air-conditioner is higher than a predetermined high load value, (g) that the battery remaining capacity (the voltage or the current value) is insufficient, (h) that the level of the negative pressure accumulated in the negative pressure booster 18 is below a desired level, and (i) that a signal for restricting S&S control is output from the body system state monitor 57.

Incidentally, the signal for restricting S&S control from the body system state monitor 57 is, for example, one of a hood opening signal from an engine hood opening/closing switch, a door opening signal from a door opening/closing switch, a release signal from a seat belt buckle switch, an airbag operation signal, and a cancellation signal from an S&S cancellation SW that selects whether or not idling stop-and-start control is required. The engine 4 is restarted when one of the signals for restricting S&S control is output.

The EPS control unit 45 and the LK control restriction determination unit 46 of the foregoing EPS control ECU 44, and the function of the deceleration S&S control unit 61 and the deceleration S&S restriction determination unit 62 of the S&S control ECU 51 constitute the control unit 33 that controls the operations of the LK control mechanism 31 and the idling stop control mechanism 32.

Then, upon fulfillment of the automatic stop conditions during the running of the vehicle 1, this control unit 33 operates the idling stop control mechanism 32 in accordance with the driving state of the vehicle 1. The automatic stop conditions include a condition that lane keeping assist steering not be executed by the LK control mechanism 31.

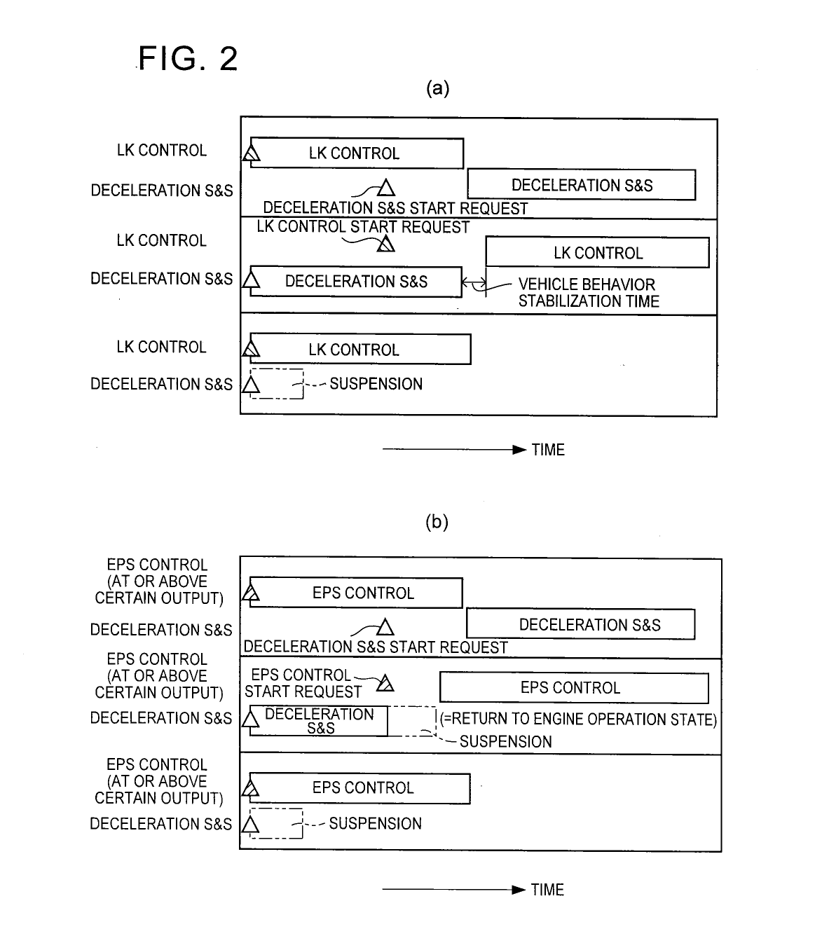

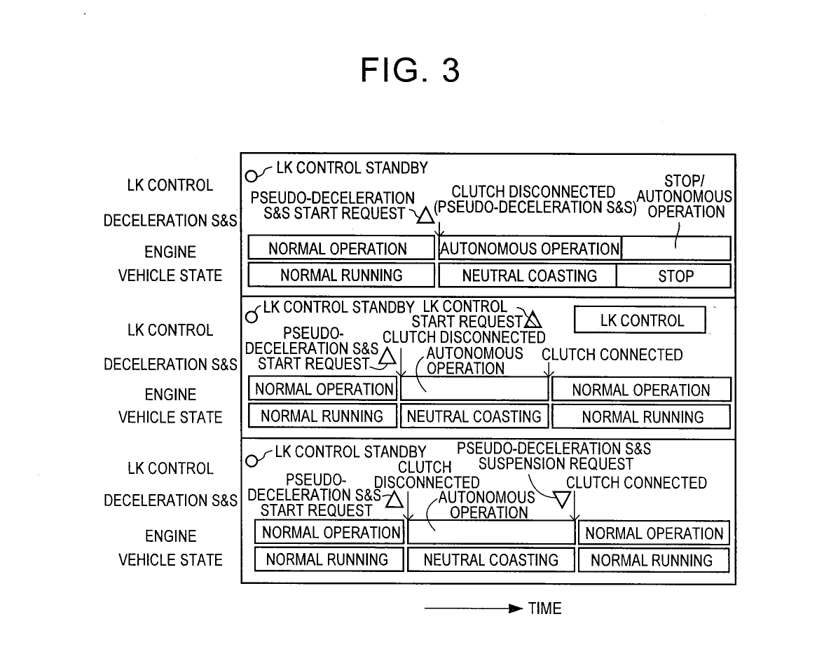

More specifically, in the control unit 33, as shown in FIG. 2(a), FIG. 2(b) and FIG. 3, the following priorities corresponding to the driving state of the vehicle 1 are set among LK control by the LK control mechanism 31, electric power steering control (hereinafter referred to as EPS control in the drawings), and deceleration S&S control by the idling stop control mechanism 32.

The upper stage of FIG. 2(a) indicates a timing for starting deceleration S&S control in the case where the LK control restriction determination unit 46 permits the execution of LK control in response to the outputting of a steering input signal for assist steering (an LK control start request) from the LK control ECU 42, the operation of the electric actuator 14 is controlled by the EPS control unit 45 in accordance with a steering input signal for lane keeping assist steering from the LK control ECU 42, and a deceleration S&S start request is generated during a period in which lane keeping assist steering for applying an assist steering force for lane keeping to the steering shaft 21 is carried out.

In this case, during the execution period of LK control, higher priority is given to the securement of safety through LK control than to the effect of reducing fuel consumption through deceleration S&S. Even when a deceleration S&S start request is generated, the end of LK control is awaited without starting deceleration S&S control. Then, deceleration S&S control is started as soon as LK control ends.

The middle stage of FIG. 2(a) indicates a timing for starting LK control in the case where the deceleration S&S restriction determination unit 62 permits the execution of deceleration S&S control when a deceleration S&S start request is generated upon fulfillment of predetermined automatic stop conditions and an LK control start request is generated in response to the emergence of a possibility of the vehicle 1 deviating from a lane during a period in which deceleration S&S control is executed by the deceleration S&S control unit 61.

In this case, during the execution period of deceleration S&S control, it may be impossible to control the vehicle 1 through LK control. Therefore, the end of deceleration S&S control is awaited without starting LK control. Then, LK control is started upon the lapse of a preset vehicle behavior stabilization time from a time point corresponding to the end of deceleration S&S control.

The lower stage of FIG. 2(a) indicates a case where a deceleration S&S start request is generated when the predetermined automatic stop conditions are fulfilled simultaneously with the outputting of a steering input signal for assist steering (an LK control start request) from the LK control ECU 42.

In this case, higher priority is given to the securement of safety through LK control than to the effect of reducing fuel consumption through deceleration S&S. Even when a deceleration S&S start request is generated, LK control is executed without starting deceleration S&S control.

The upper stage of FIG. 2(b) indicates a timing for starting deceleration S&S control in the case where a request to start EPS control by the EPS control ECU 44 of the LK control mechanism 31 is generated through a steering input and a deceleration S&S start request is generated during a period in which EPS control at or above a certain output is executed.

In this case, during the execution period of EPS control, higher priority is given to the securement of safety through EPS control than to the effect of reducing fuel consumption through deceleration S&S. Even when a deceleration S&S start request is generated, the end of EPS control is awaited without starting deceleration S&S control. Then, deceleration S&S control is started as soon as EPS control ends.

The middle stage of FIG. 2(b) indicates a timing for starting EPS control in the case where the deceleration S&S restriction determination unit 62 permits the execution of deceleration S&S control when a deceleration S&S start request is generated upon fulfillment of the predetermined automatic stop conditions, and a steering input is input to the steering wheel 21w and a request to start EPS control at or above a certain output is generated during a period in which deceleration S&S control is executed by the deceleration S&S control unit 61.

In this case, EPS control at or above a certain output is requested, so it is determined that the driver intends to give priority to steering. Deceleration S&S control is immediately suspended, and a return to an engine operation state is made by restarting the engine 4 etc. After that, a supplementary steering force is generated through EPS control to provide assistance in steering.

The lower stage of FIG. 2(b) indicates a case where a deceleration S&S start request is generated upon fulfillment of the predetermined automatic stop conditions as soon as a request to start EPS control by the EPS control ECU 44 of the LK control mechanism 31 is generated through a steering input.

In this case, higher priority is given to the securement of safety through EPS control than to the effect of reducing fuel consumption through deceleration S&S. Even when a deceleration S&S start request is generated, EPS control is executed without starting deceleration S&S control.

The upper stage of FIG. 3 indicates a procedure of pseudo-deceleration S&S control that is executed in the case where an operation to designate an LK control standby mode is carried out with the aid of the LK control selection switch 41 and the predetermined automatic stop conditions for permitting deceleration S&S control are established after the running state of the vehicle 1 shifts to a state where an assist steering force for lane keeping can be immediately applied to the steering shaft 21 from the electric actuator 14 upon the emergence of a possibility of the vehicle 1 deviating from a lane.

As described above, the LK control mechanism 31 has the LK control selection switch 41 as the mode changeover operation portion that can be changed over through a manual operation input. By operating the LK control selection switch 41, the LK control mechanism 31 can be controlled to be changed over to the standby mode in which the execution of lane keeping assist steering is permitted and the non-standby mode in which the execution of lane keeping assist steering is restricted. Then, the automatic stop conditions in the deceleration S&S control unit 61 of the idling stop control mechanism 32 include a condition that the LK control mechanism 31 be changed over to the non-standby mode. Incidentally, this will be described later.

Besides, as shown in FIG. 1, the vehicle 1 is provided with the clutch mechanism 5 capable of functioning as a disconnection mechanism that can disconnect the motive power transmission path from the engine 4 to the shift mechanism 6. Then, when all the automatic stop conditions other than the condition that the LK control mechanism 31 be changed over to the standby mode are fulfilled among the automatic stop conditions in the deceleration S&S control unit 61, the control unit 33 of the idling stop control mechanism 32 autonomously operates the engine 4 while disconnecting the motive power transmission path from the engine 4 to the shift mechanism 6 with the aid of the clutch mechanism 5 that can be electromagnetically changed over in an ON/OFF manner based on a disconnection request signal from the deceleration S&S control unit 61, thus causing the vehicle 1 to coast in a neutral state. The control of causing the vehicle 1 to coast in a neutral state through autonomous operation of this engine 4 will be referred to hereinafter as pseudo-deceleration S&S control.

Incidentally, after pseudo-deceleration S&S is executed to stop the vehicle 1 after the fulfillment of all the automatic stop conditions other than the condition that the LK control mechanism 31 be changed over to the standby mode among the automatic stop conditions, LK control can no longer be executed by the LK control mechanism 31. Therefore, the LK control mechanism 31 is substantially not in the standby mode. Accordingly, at this stop completion stage, the engine 4 can be automatically stopped in an automatically restartable manner, as is the case with normal idling stop control.

The middle stage of FIG. 3 indicates a control procedure in the case where an LK control start request is generated during a period in which pseudo-deceleration S&S control is executed under the LK control standby mode.

In this case, a steering input signal for lane keeping assist steering is output from the LK control ECU 42 during a period of pseudo-deceleration S&S control, so an LK control start request is generated. A connection request signal is emitted from the S&S control ECU 51 in response to the generation of this LK control start request. Then, the clutch mechanism 5 connects the motive power transmission path from the engine 4 to the shift mechanism 6, so the engine 4 assumes a normal operation state. When the operation state of the engine 4 is stabilized, LK control is executed.

The lower stage of FIG. 3 indicates a control procedure in the case where a pseudo-deceleration S&S suspension request other than the LK control start request is generated during a period in which pseudo-deceleration S&S control is executed under the LK control standby mode.

In this case, when a pseudo-deceleration S&S suspension request, for example, a steering input at or above a certain output from the LK control ECU 42 etc. is generated during a period of pseudo-deceleration S&S control, a connection request signal is output from the S&S control ECU 51 in response to the generation of the pseudo-deceleration S&S suspension request. Then, the clutch mechanism 5 connects the motive power transmission path from the engine 4 to the shift mechanism 6, so the engine 4 returns to the normal operation state.

In order to set such priorities, the foregoing predetermined restrictive conditions for restricting the start of deceleration S&S control in the deceleration S&S restriction determination unit 62 include a restrictive condition (j) that LK control be executed, a restrictive condition (k) that the LK control standby mode be established (there be a request to start LK control), and a restrictive condition (l) that EPS control at or above a certain output be executed, in addition to the foregoing restrictive conditions (e) to (i).

Furthermore, the restrictive conditions for not permitting lane keeping assist steering in the LK control restriction determination unit 46 include the fulfillment of one of two conditions, namely, a condition (m) that deceleration S&S control be executed and a condition (n) that the vehicle behavior stabilization time have not elapsed after deceleration S&S control.

That is, the deceleration S&S restriction determination unit 62 of the control unit 33 permits the execution of deceleration S&S control on the conditions that LK control not be executed by the EPS control unit 45 of the LK control mechanism 31, that the LK control standby mode not be established (the non-standby mode be established), and that EPS control at or above a certain output not be executed. Besides, the LK control restriction determination unit 46 of the control unit 33 permits the execution of LK control through lane keeping assist steering of the LK control mechanism 31 on the conditions that deceleration S&S control not be executed by the deceleration S&S control unit 61 of the idling stop control mechanism 32 and that the vehicle 1 be in a stable state.

Furthermore, when the other automatic stop conditions are fulfilled under a state where the LK control standby mode is established, namely, there is a request to start LK control, the control unit 33 of the idling stop control mechanism 32 executes pseudo-deceleration S&S control for causing the vehicle 1 to coast in a neutral state while autonomously operating the engine 4, as described above.

Next, a process of regulating the timing for starting deceleration S&S control and LK control that are repeatedly executed by the control unit 33 to realize the setting of the foregoing priorities, and a process of regulating the timing for starting deceleration S&S control and EPS control will be described.

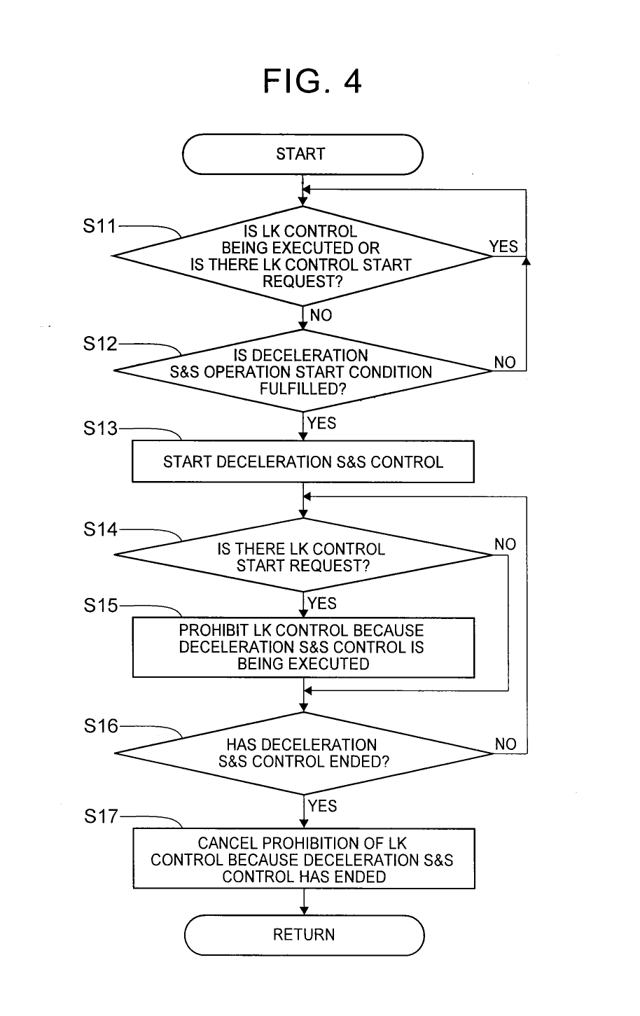

In the process of regulating the timing for starting deceleration S&S control and LK control shown in FIG. 4, it is first determined whether or not LK control is being executed, or whether or not the LK control standby mode in which there is an LK control start request is established (step S11). If LK control is being executed or there is an LK control start request (if YES in step S11), this determination step is repeated.

On the other hand, if LK control is not being executed and no LK control start request is generated (if NO in step S11), it is then determined whether or not an automatic stop condition as a condition for starting the operation of deceleration S&S control is fulfilled (step S12). If the automatic stop condition is fulfilled (if YES in step S12), deceleration S&S control is started (step S13).

It is then checked whether or not an LK control start request has been generated (step S14). If an LK control start request has been generated (if YES in step S14), a steering input signal for lane keeping assist steering as a request to start LK control is then blocked by the LK control restriction determination unit 46 because deceleration S&S control is being executed. Thus, the start of LK control is prohibited (step S15).

If no LK control start request has been generated after executing this prohibition process or when checking whether or not an LK control start request has been generated (if NO in step S14), it is then determined whether or not deceleration S&S control has ended (step S16).

Then, if deceleration S&S control has ended (if YES in step S16), the state in which the start of LK control is prohibited is then canceled because deceleration S&S control has ended. Thus, the present process ends.

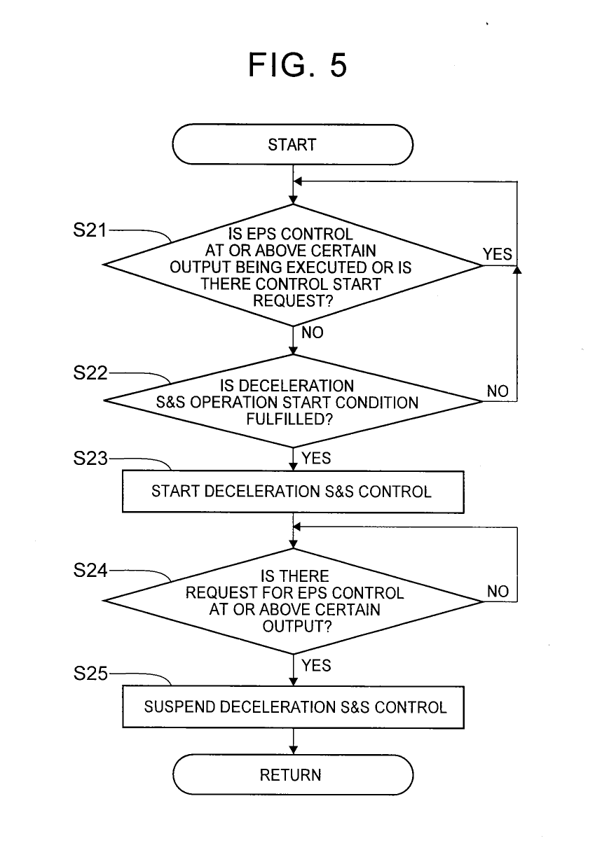

Besides, in the process of regulating the timing for starting deceleration S&S control and EPS control shown in FIG. 5, it is first determined whether or not EPS control at or above a certain output is being executed or there is a request to start EPS control at or above a certain output (step S21). If EPS control at or above a certain output is being executed or there is a request to start EPS control (if YES in step S21), this determination step is repeated.

On the other hand, if EPS control at or above a certain output is not being executed and no request to start EPS control at or above a certain output has been generated (if NO in step S21), it is then determined whether or not an automatic stop condition as a condition for starting the operation of deceleration S&S control is fulfilled (step S22). If the automatic stop condition is fulfilled (if YES in step S22), deceleration S&S control is started (step S23).

It is then checked whether or not a request to start EPS control at or above a certain output has been generated (step S24). If a request to start EPS control at or above a certain output has been generated (if YES in step S24), deceleration S&S control is then suspended (step S25).

Incidentally, if no request to start EPS control at or above a certain output has been generated at the stage of checking whether or not a request to start EPS control at or above a certain output has been generated prior to this suspension process (if NO in step S24), the step of checking on the generation is repeated.

Besides, when deceleration S&S control is suspended, the present process ends.

Next, the operation of the present embodiment of the invention will be described.

In the vehicular control apparatus 30 according to the present embodiment of the invention, the control unit 33 operates the idling stop control mechanism 32 in accordance with the driving state of the vehicle 1 upon fulfillment of the automatic stop conditions during the running of the vehicle 1. Then, the automatic stop conditions include the condition that lane keeping assist steering not be carried out by the LK control mechanism 31.

Accordingly, when the automatic stop conditions are fulfilled during the running of the vehicle 1, the idling stop control mechanism 32 operates in accordance with the driving state of the vehicle 1, and the engine 4 is automatically stopped during the running of the vehicle 1. However, the engine 4 is not automatically stopped in a state where electric power continues to be consumed in the electric power steering mechanism 13 that executes LK control. As a result, deceleration S&S control does not adversely affect LK control, and a shortage of the electric power supplied to the electric actuator 14 and a deterioration in the battery 12 are unlikely to be incurred.

That is, in LK control, a large amount of electric power is consumed to operate the electric power steering mechanism 13. However, when the electric power steering mechanism 13 is operated, the engine 4 is not stopped, and the continuous supply of electric power by the alternator 11 is possible. Therefore, a shortage of the electric power supplied to the electric actuator 14 and a deterioration in the battery 12 can be suppressed.

Besides, according to the present embodiment of the invention, LK control is not started either during the execution of deceleration S&S control. Therefore, after all, a shortage of the electric power supplied to the electric actuator 14 and a deterioration in the battery 12 are unlikely to be incurred. The apprehension about adverse effects such as the feeling of discomfort imparted to the driver due to the unavailability of an engine braking effect and the like is cast aside.

Besides, the automatic stop conditions according to the present embodiment of the invention include the condition that the LK control mechanism 31 be changed over to the non-standby mode. Therefore, the engine 4 is not automatically stopped by the idling stop control mechanism 32 when the LK control mechanism 31 is under the standby mode in which assist steering for lane keeping is immediately carried out upon the emergence of a possibility of the vehicle 1 deviating from a lane. Accordingly, the engine 4 is not automatically stopped by the idling stop control mechanism 32 under a state where assistance in steering can be provided by the electric power steering mechanism 13 for the sake of lane keeping at a deceleration stage prior to coasting or stoppage of the vehicle 1 or the like. As a result, the driveability or the kinetic performance of the vehicle 1 is not deteriorated.

Furthermore, in the present embodiment of the invention, the LK control mechanism 31 has the LK control selection switch 41 as the mode changeover operation portion. Therefore, the processing load of the control unit 33 under the non-standby mode can be alleviated.

In addition, when all the automatic stop conditions other than the condition that the LK control mechanism 31 be changed over to the standby mode are fulfilled among the automatic stop conditions, the control unit 33 of the idling stop control mechanism 32 causes the vehicle 1 to coast in a neutral state by autonomously operating the engine 4 while disconnecting the motive power transmission path from the engine 4 to the shift mechanism 6 with the aid of the clutch mechanism 5. Accordingly, fuel consumption can be reduced by autonomously operating the engine 4 in the case where the other automatic stop conditions are fulfilled when the LK control mechanism 31 is in the standby mode.

That is, in comparison with a case where inertial running is uniformly prohibited in the standby mode of LK control, fuel economy can be improved by causing the vehicle 1 to coast while autonomously (in a neutral state) operating the engine 4 simply through the prohibition of engine stop coasting. More specifically, the engine 4 and the shift mechanism 6 are decoupled from each other by the clutch mechanism 5 while maintaining the electric power of the electric power steering mechanism 13. Therefore, the friction of the engine 4 is not transmitted to the wheel 3R and 3L sides, so the engine braking force decreases. This results in an increase in the coasting distance of the vehicle 1 and an improvement in fuel economy.

Besides, the motive power transmission path from the engine 4 to the shift mechanism 6 can be smoothly disconnected and connected with the aid of the clutch mechanism 5. Therefore, when the motive power transmission path is connected etc. after a braking state or the like prior to neutral coasting of the vehicle 1 or stoppage of the vehicle is cancelled for one reason or another (e.g., a change in signal or emergency steering), the state of disconnection can be smoothly cancelled.

In this manner, according to the present embodiment of the invention, the automatic stop conditions for automatically stopping the engine 4 during the running of the vehicle 1 include the condition that lane keeping assist steering not be carried out by the LK control mechanism 31. Therefore, even in the case where deceleration S&S control as an attempt to reduce fuel consumption by automatically stopping the engine 4 during the running of the vehicle 1 is adopted, it is possible to provide the control apparatus for the vehicle 1 that makes it unlikely to adversely affect other types of control such as LK control and the like and deteriorate the battery 12.

Incidentally, in the foregoing embodiment of the invention, the vehicle 1 is a front-wheel-steer rear-wheel-drive vehicle. Needless to say, however, the vehicle 1 may be a front-wheel-drive vehicle. As a matter of course, the engine is not absolutely required to be a gasoline engine.

Besides, in the embodiment of the invention, the electric power steering mechanism 13 is employed as the steering mechanism. However, the steering mechanism may have any configuration as long as electric auxiliary steering control and driving support steering control can be executed. For example, the steering mechanism may be configured to execute auxiliary steering control and driving support steering control for lane keeping by making a changeover between oil paths or adjusting the oil pressure through the use of a solenoid valve or the like that controls an oil pressure in accordance with an electric input. Besides, it goes without saying that the power steering mechanism is not absolutely required to be of rack-and-pinion type.

Furthermore, in the embodiment of the invention, lanes are recognized in the LK control mechanism 31 based only on a camera image. However, lanes can also be recognized based on any other pieces of information that can be acquired through communication. Besides, the battery state monitor 55 and the brake negative pressure monitor 56 can be configured as, for example, a battery remaining capacity sensor and a pressure sensor respectively, but may be other components that indirectly detect a battery remaining capacity and a state of deficiency in a negative pressure booster respectively. Besides, the disconnection mechanism mentioned in the invention is only required to be capable of decoupling the engine from the wheels. The clutch between the engine and the transmission is preferably employed as the disconnection mechanism.

As described above, the invention can provide a vehicular control apparatus that makes it unlikely to adversely affect other types of control or deteriorate a battery even in the case where an attempt is made to reduce fuel consumption by automatically stopping an engine during the running of a vehicle. In consequence, the invention is useful for all vehicular control apparatuses that attempt to reduce fuel consumption by automatically stopping an engine upon fulfillment of a predetermined automatic stop condition during running.

### DESCRIPTION OF REFERENCE NUMERALS

1 . . . VEHICLE
2 . . . RUNNING DRIVE MECHANISM
3R, 3L . . . REAR WHEEL (DRIVING WHEEL)
4 . . . ENGINE (INTERNAL COMBUSTION ENGINE)
4a . . . CRANKSHAFT
5 . . . CLUTCH MECHANISM (DISCONNECTION MECHANISM)
6 . . . SHIFT MECHANISM (TRANSMISSION)
7 . . . DIFFERENTIAL DEVICE
11 . . . ALTERNATOR
12 . . . BATTERY
13 . . . ELECTRIC POWER STEERING MECHANISM (POWER STEERING MECHANISM)
14 . . . ELECTRIC ACTUATOR
15 . . . ACCELERATOR PEDAL
16 . . . BRAKE PEDAL
17 . . . MASTER CYLINDER
18 . . . NEGATIVE PRESSURE BOOSTER
19 . . . STARTER MOTOR
20 . . . STEERING MECHANISM
21 . . . STEERING SHAFT
21w . . . STEERING WHEEL (WHEEL, STEERING INPUT MEMBER)
22 . . . STEERING INPUT SENSOR
23 . . . BEVEL GEAR
24 . . . TURNING ANGLE SENSOR
26 . . . RACK
30 . . . CONTROL APPARATUS (VEHICULAR CONTROL APPARATUS)
31 . . . LK CONTROL MECHANISM (LANE KEEPING ASSIST CONTROL MECHANISM)
32 . . . IDLING STOP CONTROL MECHANISM (AUTOMATIC STOP CONTROL MECHANISM)
33 . . . CONTROL UNIT
41 . . . LK CONTROL SELECTION SWITCH (MODE CHANGEOVER OPERATION PORTION)
42 . . . LK CONTROL ECU (LANE KEEPING ASSIST CONTROL ECU)
43 . . . IMAGE ACQUISITION UNIT
44 . . . EPS CONTROL ECU (ELECTRIC POWER STEERING CONTROL ECU)
45 . . . EPS CONTROL UNIT
46 . . . LK CONTROL RESTRICTION DETERMINATION UNIT
51 . . . S&S CONTROL ECU
52 . . . ENGINE ECU
53 . . . BRAKE ECU
54 . . . AIR-CONDITIONING ECU
55 . . . BATTERY STATE MONITOR
56 . . . BRAKE NEGATIVE PRESSURE MONITOR
57 . . . BODY SYSTEM STATE MONITOR
58 . . . METER ECU
59 . . . BRAKE SWITCH
61 . . . DECELERATION S&S CONTROL UNIT (DECELERATION IDLING STOP-AND-START CONTROL UNIT)
62 . . . DECELERATION S&S RESTRICTION DETERMINATION UNIT
Jg1, Jg2 . . . DETERMINATION RESULT
OP1 . . . LK CONTROL REQUEST STATE SIGNAL
OP2 . . . DECELERATION S&S CONTROL STATE SIGNAL
OP3 . . . LK CONTROL STATE SIGNAL

1. A control apparatus for a vehicle, the vehicle including an engine, a transmission, a generator and a power steering mechanism, the engine generates a motive power, the transmission transmits the motive power of the engine, the generator is driven by the engine, and the power steering mechanism provides assistance in operating a steering wheel through a use of an electric power generated by the generator, the control apparatus comprising:
a lane keeping assist control mechanism configured to execute lane keeping assist control for preventing the vehicle from deviating from a running lane by the power steering mechanism; and
an automatic stop control mechanism configured to stop the engine upon fulfillment of predetermined automatic stop conditions during running of the vehicle, the automatic stop conditions include a condition that the lane keeping assist control not be executed.

2. The control apparatus according to claim 1, wherein the lane keeping assist control mechanism is configured to be changed over between a standby mode and a non-standby mode, the standby mode is a mode wherein the lane keeping assist control is permitted to be executed, and the non-standby mode is a mode wherein the lane keeping assist control is restrained from being executed, and
the automatic stop conditions include a condition that the lane keeping assist control mechanism be changed over to the non-standby mode.

3. The control apparatus according to claim 2, wherein the lane keeping assist control mechanism includes a switch, the switch is configured to change over between the standby mode and the non-standby mode through a manual operation input.

4. The control apparatus according to claim 2, wherein
the vehicle includes a disconnection mechanism, the disconnection mechanism is configured to disconnect a motive power transmission path from the engine to the transmission, and
the automatic stop control mechanism causes the vehicle to coast by autonomously operating the engine while disconnecting the motive power transmission path from the engine to the transmission with the disconnection mechanism when all the automatic stop conditions other than a condition that the lane keeping assist control mechanism be changed over to the standby mode are fulfilled among the automatic stop conditions.

5. The control apparatus according to claim 4, wherein the disconnection mechanism includes a clutch that can disconnect and connect the motive power transmission path from the engine to the running drive mechanism.

6. The control apparatus according to claim 1, wherein
the power steering mechanism includes an electric actuator that operates based on a steering input signal corresponding to a steering input signal to a steering input member, and the power steering mechanism is configured to generate a steering assist force with the electric actuator,
the lane keeping assist control mechanism is configured to generate the steering input signal, the steering input signal is a signal that assists steering to prevent the vehicle from deviating from a running lane, and
the lane keeping assist control mechanism is configured to cause the power steering mechanism to carry out lane keeping assist steering corresponding to the steering input signal.
